(19) United States
(12) Patent Application Publication
(10) Pub. No.: US 2026/0289660 A1
(43) Pub. Date: Sep. 24, 2026

(54) LOCATION-BASED DONATION SYSTEM

(71) Applicant: Thomas Haag, Edina, MN (US)

(72) Inventor: Thomas Haag, Edina, MN (US)

(21) Appl. No.: 19/575,577

(22) Filed: Mar. 23, 2026

Related U.S. Application Data
(60) Provisional application No. 63/775,644, filed on Mar. 21, 2025.

(51) Int. Cl. G06Q 40/02; G06K 7/14

(52) U.S. Cl. CPC G06Q 40/0225; G06K 7/1417

(57) ABSTRACT

A method, comprising associating a first potential donor with a first location; associating a second potential donor with a second location; receiving a first donation from the first potential donor; receiving a second donation from the second potential donor; and controlling a display to present the first donation associated with the first location and the second donation associated with the second location.

### FIELD OF THE INVENTION

This invention relates generally to electronic donation systems, and more specifically to systems for facilitating contributions to student athlete compensation programs, including Name, Image, and Likeness (NIL) programs and athletic revenue sharing funds.

### BACKGROUND

College athletes historically were not paid salaries like professional athletes, but the landscape of college athlete compensation has changed significantly in recent years. College athletes may now receive compensation through two primary mechanisms. First, athletes may receive compensation through use of their Name, Image, and Likeness (NIL), enabling college athletes to enter into endorsement deals with companies and to receive donations through NIL collectives and platforms.

Second, colleges and universities may now compensate athletes directly through revenue sharing arrangements administered through a school's athletic department. In some examples, mobile crowdfunding platforms like GoFundMe, Venmo, or CashApp may be used by donors to donate funds to athletes through NIL channels. In other examples, NIL donation-specific applications like Opendors or Fundraisup may present users with athlete profiles and similarly enable donors to donate funds to athletes. However, existing platforms do not allow a donor to select between contributing to a school's official NIL program and contributing to a school's athletic revenue sharing fund, nor do they facilitate location-based, gamified competitions between donors that encourage increased giving to either compensation pathway.

### BRIEF DESCRIPTION OF THE DRAWINGS

FIG. 1 is a block diagram depicting a donation payment system configured to associate potential donors with different locations according to some embodiments.

FIG. 2 is a diagram showing a non-limiting example of a display of a mobile device controlled to present location-based donation information to a user according to some embodiments.

FIG. 3 is a flow diagram that depicts one example of a method of implementing a donation payment system according to some embodiments.

### DETAILED DESCRIPTION

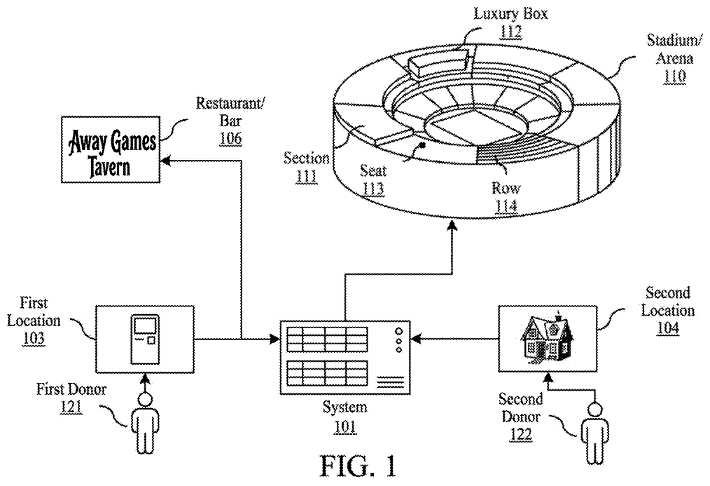

FIG. 1 is a diagram depicting a donation payment system 101 configured to associate potential donors with different locations 103, 104 according to some embodiments. The different locations 103, 104 are in some form related as places where potential donors, including at least a first donor 121 and a second donor 122 as depicted in the example of FIG. 1 are likely to travel or congregate.

In some examples, the different locations 103, 104 may correspond to a sporting event that takes place in a stadium 110 as shown in FIG. 1 example. In other examples, the different locations 103, 104 are otherwise associated with donations. For example, the different locations 103, 104 may be different bars or restaurants that each host a fundraising event for a charity, non-profit organization, or the like not involved in athletics. In other examples, the different

System 101 may be implemented via software instructions that are stored in a memory that cause a processor to perform the various functions of the system 101 described herein. Such instructions may be executed by processors of one or more computing devices coupled to one another via a network, examples of which include one or more mobile devices, servers, or other computing devices that include a processor configured to execute instructions. Such instructions may additionally be embodied on one or more non-transitory computer-readable media such that, when executed by a processor, the instructions cause the processor to perform the functions of the system 101 described herein.

According to the example shown in FIG. 1, where the different locations 103, 104 correspond to a sporting event, the sporting event may take place in a stadium 110, which may be an indoor or outdoor stadium, arena, or other similar venue with seating for fans to view a sporting event such as American football, soccer, basketball, tennis, track and field, swimming, hockey, or the like.

As described herein, a sporting event includes participants such as those associated with a team or athlete competing in the sporting event, which may include college student athletes, coaches, team staff, mascots, or others in some way associated with a sporting event who may be eligible for compensation through NIL. The sporting event may be between respective teams associated with different universities, colleges, or other learning institutions. In other examples, the sporting event may be between other professional, semi-professional, uncompensated, or other teams for which participants may be compensated through donations by donors.

FIG. 1 depicts various locations that may correspond to a sporting event, i.e., positions where potential donors (e.g., who may be fans of one or more teams and/or athletes involved with a sporting event) are commonly located that are in some way connected to an athlete or team, such as those places where potential donors may congregate to view a sporting event or otherwise congregate with others who are also potential donors (e.g., other fans of the one or more teams and/or athletes). For example, such locations may include a stadium 110 itself, one or more seating sections 111 in the stadium 110, one or more luxury boxes 112 of the stadium 110, and/or particular row 114 and/or particular seat 113 within a section 111 of the stadium 110 as shown in FIG. 1 where potential donors are likely to sit or stand during a sporting event. In other examples not depicted, such locations may include other areas associated with a stadium, such as one or more concession areas, restrooms, ticketing areas, outdoor viewing areas, parking lots, designated tailgating areas, in-stadium restaurants, bars, biergartens, or the like where potential donors are likely to congregate or otherwise visit before, during, or after the sporting event.

In other examples, such locations may include places outside a stadium or stadium complex itself that otherwise correspond to the sporting event, where potential donors are likely to congregate before, during, or after a sporting event. For example, such locations may include a restaurant, bar, student union, fraternity, public viewing area, or the like that is near a stadium where a sporting event takes place (e.g., in the same city, town, or region where the sporting

System 101 is uniquely configured to facilitate donations to participants of a sporting event by associating potential donors with different locations 103, 104 that correspond to the same sporting event. In the example of FIG. 1, the different locations 103, 104 include a first location 103 and a second location 104. According to this example, system 101 may associate (e.g., store in a memory an association that identifies a donor as being associated with a location) a first donor 121 with a first location 103 that corresponds to a sporting event, associate a second donor 122 with a second location 104 that also corresponds to the sporting event, and use these associations to facilitation donations from the first and second donors 121, 122.

For example, system 101 may be implemented at least in part by application software executing on a user's mobile device (e.g., a computing device such as a touchscreen phone, tablet, laptop, watch, smart glasses, or the like) to control a display of the mobile device to present the first donation associated with the first location 103 and the second donation associated with the second location 104 to a user of the system 101 (e.g., a donor or other user of the system 101). In some examples, system 101 may be configured to enable a competition between the first and second donors 121, 122 to facilitation donations to the participants. In some examples, the first donor 121 is a first group of one or more donor(s), the second donor 122 is a second group of one or more donor(s), and the system 101 is configured to enable a competition between the respective groups of donor(s) 121, 122. System 101 may further be configured to receive donations from the respective groups of donor(s) 121, 122 and present the donations in real-time via the display(s) as the donations are received and/or verified to facilitate the competition.

In some examples, the first location 103 may be associated with a team participating in the sporting event, and the second location 104 is associated with the same team participating in the sporting event (e.g., different bars in the same city/region, different sections 111, luxury boxes 112, rows 114, and/or seats 113 within a stadium 110). In other examples, the first location 103 may be associated with a first team participating in the sporting event, and the second location 104 is associated with a second team competing with the first team in the sporting event (e.g., home and away team bars). In some examples, system 101 may be configured to present a donor with multiple display views that each represent different competitions that the donor has participated in or that are available for the donor to participate in based on a location associated with a donor. For example, the system 101 may cause a display to be selectable by a user to transition between competitions between different locations, different teams, different sporting events, and/or with different incentives.

In some examples, system 101 is configured to associate a user with a location at least in part on QR codes associated with the location. For example, the system may associate a first donor(s) 121 with the first location 103 based on receiving input indicating the first donor 121

In some examples, the respective first and second QR codes may be distributed at the first and second locations. For example, where the location is a bar, restaurant, or other eating/drinking establishment, luxury box 112, or the like, QR codes may be displayed on tables, bars, menus, or otherwise displayed to patrons. As another example, where the location is a section 111, seat 113, or other location within a stadium, QR codes may be presented on seating of the stadium. In some examples, scanning such a QR code may bring a user to a landing page that directs a user to an application store to download an application and/or open an already installed application on the user's mobile device configured to control the display(s) to present the first and second donations as described above.

In other examples, the system 101 may use other means, alone or in combination with scanning QR codes as described above, to associate a potential donor with a location. For example, the system 101 may associate a user with a particular location receiving user input (e.g., via selecting a button, pulldown menu, indicated position on a map of a stadium or area, voice command, or the like) indicating that the user seeks to be associated with a particular locations that corresponds to a sporting event. In still other examples, system 101 may be configured to use geofencing to detect based on location data when a user's mobile device has entered a particular geofenced area to associate the user with the location as a donor.

In still other examples, system 101 may associate a potential donor with a location using one or more short-range wireless or signal-based technologies, alone or in combination with the location-detection mechanisms described above. For example, system 101 may detect a signal broadcast by a short-range wireless transmitter, such as a Bluetooth Low Energy (BLE) beacon, deployed at or near a location, and associate a user's mobile device that receives such a signal with the corresponding location. In other examples, system 101 may associate a donor with a location based on a near-field communication (NFC) interaction between a donor's mobile device and an NFC element deployed at the location, such as by tapping a mobile device against an NFC-enabled tag affixed to a table, seat, or other venue fixture. In still other examples, system 101 may associate a donor with a location based on identification of a wireless network access point identifier associated with the location, such as a network name or identifier specific to a venue or area within a venue. In still other examples, system 101 may associate a donor with a location based on an identifier encoded in a ticket, wristband, or other admission credential for an event at the location, such as by scanning a barcode printed on the credential that encodes a section, row, seat, or other location identifier. In still other examples, system 101 may associate a donor with a location based on an acoustic or ultrasonic signal broadcast at the location and detected by a microphone of the donor's mobile device. System 101 may be configured to accept any such signal or identifier, alone or in combination, as input sufficient to associate a donor with a location for purposes of the donation attribution and display functions described herein. For example, in a stadium application, BLE beacons may be installed in each seating section such that when a donor's mobile device enters a section, system 101 automatically detects the beacon signal and associates the donor with that section without requiring any manual scanning action. As another example, a bar participating in a fundraising campaign may affix NFC-enabled tags to tables, allowing patrons to tap their phone against a tag to associate themselves with the bar as a donation location. As another example, a fan attending a sporting event may scan their printed or digital admission ticket using the system 101 application, which reads the barcode encoded with the fan's seat section and row to associate the donor with that specific stadium location, without requiring a separate location-specific QR code.

In still other examples, system 101 may enable a user/donor to send an invitation, which may include a QR code, to another person to become a donor associated with a particular location. For example, a donor at a bar who recently scanned a QR code and was associated with the bar sends the invitation (optionally including the QR code) to an acquaintance not at the bar, upon acceptance the acquaintance may be associated with the bar as a location such that donations from the acquaintance are attributed to the bar by the system 101.

In some examples, system 101 may be configured to update a previously determined association between a potential donor and a location. For example, system 101 may determine, based on location data associated with a donor's mobile device, detect that donor has changed from a first location 103 associated with a sporting event to a second location 104 associated with the sporting event, for example if the donor changed their seat in the stadium or travelled from one bar/restaurant to another. Accordingly, system 101 may automatically transition such a donor to a second group or donor(s) associated with the second location 104. In some examples, system 101 may instead first present a donor with an option to change their association from the first location 103 to the second location 104 or to maintain the existing association between the donor and the first location 103. In still other examples, system 101 may change a donor's association to the second location 104 based on receiving input that the donor has scanned a QR code associated with the second location 104 or otherwise indicates that the donor seeks to change the user's association in the system to another location.

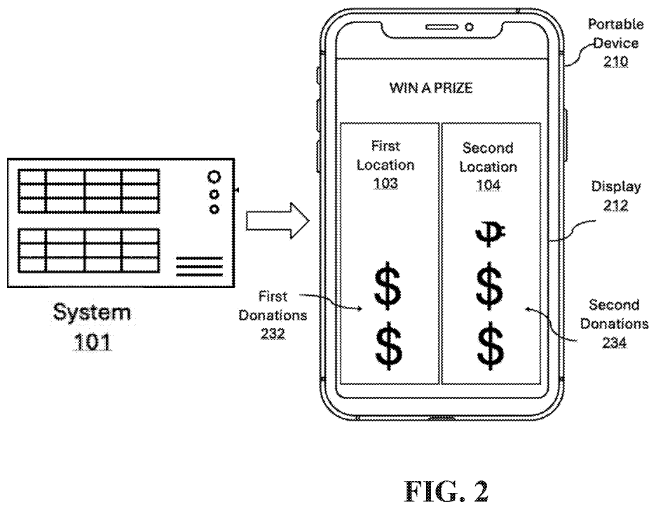

FIG. 2 is a diagram showing a non-limiting example of a display 212 of a mobile device 210 controlled by system 101 to present location-based donation information to a user according to some embodiments. As shown in FIG. 2, the display 212 is controlled to present first donations 232 associated with a first location 203 (i.e., from donor(s) previously associated with the first location 103), and second donations 234 associated with the second location (i.e., from donor(s) previously associated with the second location 104).

The first and second donations 232, 234 may be presented by the display 212 in juxtaposition (next to) with one another, or otherwise viewable together on the display 212 by a user of the mobile device 210. For example, the first and second donations 232, 234 may be presented symbolically as shown by the dollar signs in the FIG. 2 example, by graphs or charts, actual and/or estimated dollar amounts, or the like. In some examples, system 101 may control the display 212 to present the first and second donations 232, 234 in aggregate, including a total amount of money collected thus far from the respective first donor(s) 121 and the second donor(s) 122. In other examples, system 101 may also or instead be configured to control the display 212 to present an amount and/or number of donations 232, 234 from specific ones of the first donor(s) 121 and/or second donor(s) 122.

As mentioned above, in some examples, the system 101 is configured to control the display 212 to present the first donations 232 and the second donations 234 to facilitate competition between the first donor(s) 121 and the second donor(s) 122. In some examples, although not shown in FIG. 2, system 101 may further control the display to show the respective participants in a sporting event that the first and second locations 103, 104 are respectively associated with. For example, if the first and second locations 103, 104 are each associated with a different team participating in the sporting event a name or symbol representing the respective teams may be displayed with the respective first and second locations 103, 104.

As represented by the text “WIN A PRIZE” in FIG. 2, in some examples, the system 101 may further present an incentive to winning location(s), i.e., location or locations for which the most donations are received and/or for which a threshold amount of donations was met and/or exceeded. For example, the system 101 may present a VIP access offer for a participant in a sporting event, such that an athlete, coach, mascot or the like to visits the winning location(s) for an event. In other examples, the system 101 may control the display 212 to present an offer to make a further donation (e.g., matching donation) to a charity organization and/or to sporting event participants on behalf of the winning location(s). In still other examples, the system 101 may control the display 212 to present an offer to provide a marketing grant to the winning location(s). In still other examples, the system 101 may control the display 212 to present an offer for donor(s) associated with the winning location(s) to be included in a promotional video. In still other examples, the system may control the display 212 to present an offer to for donor(s) associated with the winning location(s) to be provided with one or more free food and/or drink items. In still other examples, the system may control the display 212 to present an offer to for donor(s) and/or winning location(s) to be provided with sporting equipment such as a signed jersey, helmet, or the like. In still other examples, the system 101 may control the display 212 to present an offer to for

In some examples, the system 101 may be configured to facilitate a competition between locations (e.g., bars, restaurants, and the like) according to a tiered program, where participant locations are organized into different tiers (e.g., bronze, silver, gold, platinum) based on an amount of donations received by the system 101. According to this example, each respective tier may receive incentives as described above and/or exclusive co-branded signage and/or merchandise giveaways.

In some examples, the system 101 may be further configured to generate social media posts to one or more users of the system 101 indicating the result of competitions, including the winner of a competition and/or a prize awarded. In some examples, the system 101 may be further configured to utilize mobile device cameras to capture images of donors scanning location-specific QR codes and may post the same to social media.

In some examples, the system 101 may be further configured to offer one or more incentives (e.g., digital wallpapers depicting a team, athlete and/or logo, discount codes for merchandise, free tickets, and the like) to donor(s) that scan QR codes associated with the system 101 more than a predetermined number of times during a specified time period (e.g., multiple times per month).

In some examples, the system 101 may facilitate competition between locations 103, 104 associated with a sporting event in a distal location (where the home team is competing in another team's stadium). According to these examples, the first and second locations 103, 104 may be different bars/restaurants in the same city, and the system 101 facilitates the competition at substantially the same time as sporting event is taking place in the distal location.

In some examples, system 101 may be configured to control displays other than a mobile device display 212 as shown in FIG. 2. For example, system 101 may be configured to control a stadium projector or screen, display in a bar/restaurant, or other display to present location-based donation information as described herein.

In some examples, the system 101 may randomly select one or more locations for a competition. In some examples, system 101 may limit a competition to a particular time period. For example, system 101 may limit a competition to the first half of a sporting event, the second half of a sporting event, a duration of the sporting event, within an hour before and/or after the sporting event, or any other time period associated with a sporting event.

In some examples, where the respective locations are associated with different sections 111, luxury boxes 112, seats 113, or other location(s) in a stadium 110, system 101 may be configured to present results via a jumbotron or other display of the stadium viewable during the sporting event. In some examples, the system 101 may be configured to control a jumbotron in a first stadium where the sporting event occurs and a jumbotron in a second stadium of an away team competing in the sporting event.

In some examples, the system 101 may be configured to offer one or more participating locations with an incentive to double donation amounts during a particular time period (i.e., a half or quarter of a sporting event). In some examples, the system 101 may be configured to present the name(s), photo, and/or other representation of leading donor(s) via a jumbotron or other stadium display.

In some examples, system 101 may be configured to present different displays (from the same or different apps), which may be available and/or useful to different users of the system 101. For example, system 101 may be configured to control a display to present a screen that enables owners, managers, employees, or other personnel associated with a location (e.g., a bar/restaurant) to view all donation data associated with that location, including donation data across multiple sporting events with which the location is associated. In other examples, the system 101 may implement a stadium dashboard, which may be used by managers or employees of a stadium and/or potential donors in the stadium to access donation data associated with locations within the stadium or greater stadium complex.

In some examples, system 101 may be configured to present a donor with a selectable option enabling the donor to direct their donation to one of a plurality of compensation pathways available to participants in a sporting event. For example, system 101 may control the display 212 to present the donor with the option to direct a donation to a school's official NIL program, through which funds are distributed to athletes in connection with their name, image, and likeness rights, or alternatively to direct a donation to a school's athletic revenue sharing fund, through which the school directly compensates athletes participating in the sporting event. In some examples, system 101 may present both compensation pathway options on the display 212 simultaneously, enabling a donor to allocate a donation between the two pathways in any proportion. In some examples, the selected compensation pathway may be associated with the donor's location, such that aggregate donations from donors associated with a particular location reflect both the total amount donated and the respective allocations between NIL and revenue sharing pathways.

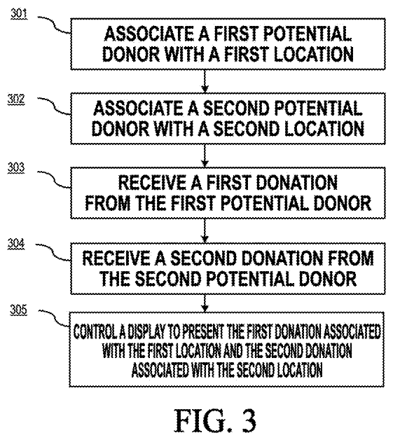

FIG. 3 is a flow diagram that depicts one example of a method of facilitating donations to participants in a sporting event according to some embodiments. As shown in FIG. 3, at 301, the method includes associating a first potential donor 121 with a first location 103. As also shown in FIG. 3, at 302, the method further includes associating a second potential donor 122 with a second location 104. As also shown in FIG. 3, at 303, the method further includes receiving a first donation from the first potential donor 121. As also shown in FIG. 3, at 304, the method further includes receiving a second donation from the second potential donor 122. As also shown in FIG. 3, at 305, the method further includes controlling a display 212 to present the first donation 232 associated with the first location 103 and the second donation 234 associated with the second location 103.

In some examples, system 101 may be configured to associate a potential donor with a location and receive and attribute donations from that donor to the location without implementing a competition between multiple locations. For example, system 101 may track and display donations associated with a single location—such as a bar, restaurant, seating section, or digital donor community—independently of any comparison to donations from another location. Such venue-attributed donation functionality enables a location to serve as a standalone fundraising node within the system 101, and the system 101 may control a display to present the total amount raised by donors associated with the location, individual donor contributions, donation history, or other donation data associated with the location, without juxtaposing such data against that of a competing location. In some examples, system 101 may offer both standalone venue-attribution functionality and competitive multi-location functionality within the same platform, enabling campaign organizers to configure one or more locations in either mode. For example, a university booster club may use system 101 to track and display the total donations contributed by its members toward a student athlete during an away game, presenting a running total on members'mobile devices without any comparison to donations from another group or location. As another example, a bar hosting a watch party may configure system 101 to serve as a standalone donation display, allowing patrons to donate to the home team's athletes and showing the venue's cumulative total on a screen inside the bar, independent of any inter-venue competition.

In some examples, a location as described herein may include a digital donor community, which may be defined by a common affinity, interest, or affiliation among its members rather than by shared physical presence at a particular venue. For example, a digital donor community may include fans of a particular athlete or team organized through a social media platform, fan forum, online messaging application, alumni association, booster club, or similar group, where individual members may participate remotely from various physical locations. System 101 may be configured to associate a potential donor with a digital donor community based on the donor having joined, been invited to, or registered within the community, such as by accepting an invitation link, selecting the community from a list presented within system 101, or scanning a QR code associated with the community. In some examples, digital donor communities may be defined by criteria including, without limitation, team affiliation, sport, geographic region, alumni status, booster club membership, or any other criteria established by a campaign organizer or administrator of system 101. In some examples, system 101 may enable a competition between a physical venue location (e.g., a bar or stadium section) and a digital donor community, or between two or more digital donor communities, in the same manner as a competition between two physical venue locations as described above. For example, an alumni association for a university may establish a digital donor community within system 101, enabling graduates located across the country to collectively donate to their university's athletes during a championship tournament, with system 101 displaying the community's aggregate total in real time on community members'mobile devices. As another example, a digital donor community organized around a particular athlete's fan following may compete within system 101 against fans gathered at a local watch-party bar, with both the remote community members and the bar's in-person patrons able to view their respective running totals side-by-side on their mobile devices throughout the event.

In some examples, system 101 may be configured to facilitate corporate or sponsor donation matching in connection with a fundraising campaign or sporting event. For example, a corporate or organizational sponsor may commit, through system 101 or an administrator of system 101, to provide matching donations corresponding to at least a portion of donations received from donors associated with one or more locations or digital donor communities during a specified time period—such as during a particular sporting event, season, or defined campaign window—up to a specified maximum matching amount. System 101 may be configured to receive and store a sponsor matching commitment, including relevant parameters such as the sponsor identity, applicable matching ratio (e.g., one-to-one, two-to-one), applicable locations or communities, maximum matching amount, and applicable time period. System 101 may further be configured to control a display to present matching donation information to potential donors, including the sponsor commitment, the current matched donation total, any remaining matching balance, and the cumulative effect of the matching on total donations raised. In some examples, system 101 may present matching donation information as an additional incentive to encourage further donations—for example, by displaying a real-time total of matched donations or a threshold donation amount required to trigger or maintain the sponsor match. In some examples, a sponsor matching commitment may be conditioned on competition performance, for example by providing a matching contribution to the winning location or donor community in a competition facilitated by system 101. For example, a regional sports apparel company may commit through system 101 to match, on a two-to-one basis, all donations received from donors associated with any participating watch-party location during the first half of a conference championship game, up to a total matching contribution of $25,000, with system 101 displaying the sponsor's name, the current matched total, and the remaining matching balance on participant mobile devices and venue screens throughout the event. As another example, a sponsor matching commitment may be structured as a competition prize, where the sponsor commits to a matching donation equal to the total raised by the winning location, payable to the recipient athlete or a designated charity on behalf of the winning location's donors.

In some examples, system 101 may be configured to deploy location identifiers, such as QR codes, at retail venues that are not directly affiliated with a sporting event but that are patronized by fans or potential donors associated with a team or athlete. For example, sporting goods retailers, convenience stores, gas stations, or other commercial establishments may display QR codes associated with system 101, enabling customers at those locations to donate to a team or athlete while conducting ordinary retail transactions. In such examples, the retail venue may serve as a participating location within system 101, with donations made by customers at the retail venue attributed to the retail location and eligible to compete against donations from other participating venues or communities as described herein. For example, a sporting goods retailer may display a school-branded QR code at checkout that allows a customer to make a micro-donation to the school's athletes in seconds, with the retailer's cumulative donations appearing on a leaderboard alongside donations from sports bars, stadium sections, and other participating locations.

In some examples, system 101 may be configured to capture donor identification data from a potential donor in connection with receiving a donation, and to transmit that data to a donor management system associated with a participant, team, organization, or athletic department affiliated with the event. For example, upon completing a donation through system 101, a donor may provide identifying information such as an email address, name, or an existing donor identifier assigned by an athletic department or fundraising organization. System 101 may be configured to transmit such donor identification data, together with relevant donation information such as donation amount, associated location, and timestamp, to a donor management system or customer relationship management (CRM) platform used by the athletic department or organization to track donor activity. In some examples, donors who have existing donor identifiers within an athletic department's system may opt in to have their donations credited toward existing donor recognition programs, point systems, or annual fund milestones tracked within the donor management system. In this manner, system 101 may serve as a top-of-funnel donor acquisition and engagement tool that feeds new and existing donor activity into an athletic department's broader fundraising and development pipeline.

In some examples, system 101 may be configured to present, via a display of a donor's mobile device, access to a ticketing platform associated with an event corresponding to a location with which the donor is associated. For example, following a donation through system 101, the system may control the display to present a selectable link or button that, upon selection, navigates the donor's mobile device to an official ticketing portal for the event, enabling the donor to purchase tickets to the event in the same session. In some examples, system 101 may be configured to interface with a third-party ticketing platform that provides ticketing services for the event, such as a ticketing platform operated by or on behalf of an athletic conference, university, or event venue. In some examples, a single scan of a location identifier, such as a school-branded QR code, may initiate a session within system 101 that enables a donor to both make a donation to a participating athlete or organization and access official ticket purchasing for the event, converting a fan's engagement with a fundraising campaign into a ticketing transaction in the same mobile session.

In some examples, system 101 may be configured to generate and present an administrative dashboard accessible to managers, employees, or administrators associated with a venue, athletic department, or organization participating in the system 101. The administrative dashboard may present aggregated donation data across a plurality of locations associated with one or more events, including but not limited to a total donation amount, a total number of donors, an average gift amount, a ranking of participating locations by total donations received, a breakdown of donations by sport or event type, and a time-series view of donation activity over a specified period. In some examples, the administrative dashboard may further present data indicating the number of times location identifiers such as QR codes have been scanned, enabling administrators to assess fan engagement levels across participating venues. In some examples, system 101 may be configured to provide a stadium-specific dashboard view that presents donation and engagement data associated specifically with locations within a stadium complex, including seating sections, luxury boxes, concession areas, and other in-stadium locations, enabling stadium managers or athletic department staff to monitor real-time fundraising activity during a sporting event.

In some examples, system 101 may be further configured to update the display 212 in real time as donations are received from donors associated with the respective first and second locations 103, 104. For example, system 101 may establish a persistent communication channel (e.g., a WebSocket connection or server-sent event stream) between a server implementing system 101 and each mobile device 210 displaying the first and second donations 232, 234, and may push updated donation totals to each mobile device 210 via the persistent communication channel as donations are received and verified by the system 101. In some examples, system 101 may update the display 212 at a defined interval (e.g., every 30 seconds or every minute) rather than after each individual donation, to present an aggregated view of competition progress during the sporting event. In some examples, system 101 may control the display 212 to present the first and second donations 232, 234 as a graphical representation, such as a bar chart, progress meter, or other visual element that dynamically updates to reflect current donation totals in real time as the sporting event progresses, so that donors at respective locations can observe the competition and be encouraged to donate further.

In some examples, in which system 101 uses geofencing to associate a donor with a location, system 101 may determine the location of a donor's mobile device using one or more positioning technologies. For example, system 101 may receive global positioning system (GPS) coordinates transmitted by a GPS receiver of the mobile device and compare those coordinates to a geofenced boundary associated with the location. In other examples, system 101 may determine the location of the mobile device based on position triangulation using signals received from a plurality of cellular network base stations. In still other examples, system 101 may determine that a mobile device is within a particular location based on the mobile device establishing a connection with a wireless local area network (e.g., a Wi-Fi network) associated with the location, such that system 101 recognizes a match between the mobile device's network connection and a known network associated with the location. In still other examples, system 101 may determine location based on signals received from one or more short-range wireless transmitters, such as Bluetooth Low Energy (BLE) beacons or near-field communication (NFC) tags, positioned within or at the entrance to the location. In examples in which the location is a seating section, row, or seat within a stadium, system 101 may use a plurality of short-range wireless transmitters positioned throughout the stadium to determine a donor's location within a plurality of sub-areas of the stadium with greater granularity than GPS alone provides, allowing the system 101 to associate a donor with a specific seating section, luxury box, or individual seat.

In some examples, system 101 may maintain, in a memory, a data object associated with each location configured to store information associated with a group of one or more donors associated with that location. The data object may include one or more data fields representative of parameters including at least one of: a location identifier associated with the location; an event identifier associated with a sporting event or other event to which the location corresponds; an event date and event time; a time at which the association between a donor and the location was established; an aggregate donation amount received from donors associated with the location; identifiers of each of the one or more donors associated with the location; geolocation data associated with the location; and one or more fraud and safety protocols associated with the location. In some examples, the data object may be time-limited, such that associations between donors and the location are valid only during a defined time period (e.g., during the sporting event, during a window before and/or after the sporting event, or during a particular portion of the sporting event such as a first half, second half, or individual quarter). In some examples, the data object may be geolocation-limited, such that new donors may only be associated with the location if their mobile device is detected within a defined geographic boundary associated with the location at the time of association.

In some examples, system 101 may be further configured to implement donation matching, wherein a sponsoring entity (e.g., a corporate sponsor, university, athletic department, or other organization) commits to matching donations received by system 101 up to a predetermined threshold amount. In some examples, system 101 may control the display 212 to present a current matching status to donors, for example a progress meter or numerical display indicating how much of the matching threshold has been fulfilled by donations received thus far. In some examples, system 101 may be configured to generate and transmit an automated notification (e.g., a push notification, in-app alert, or text message) to donors associated with a location if donations from that location approach or reach a donation threshold that triggers an incentive or matching donation, to encourage additional donations prior to the threshold being reached. In some examples, upon determining that a competition has concluded (e.g., that the sporting event has ended or a defined time period has elapsed), system 101 may automatically determine the winning location based on aggregate donation totals, generate the applicable incentive offer, and communicate the incentive offer to the participant (e.g., athlete, coach, or team) and to the donors associated with the winning location.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
associating a first potential donor with a first location;
associating a second potential donor with a second location;
receiving a first donation from the first potential donor;
receiving a second donation from the second potential donor; and
controlling a display to present the first donation associated with the first location and the second donation associated with the second location.

2. The method of claim 1, wherein associating the first potential donor with the first location includes receiving input indicating a user has scanned a first QR code associated with the first location, and associating the second potential donor with the second location includes receiving input indicating a user has scanned a second QR code associated with the second location.

3. The method of claim 1, further comprising:
associating the first potential donor with the first location based on comparing location data for the first potential donor to a first geofenced area associated with the first location; and
associating the second potential donor with the second location based on comparing location data for the second potential donor to a second geofenced area associated with the second location.

4. The method of claim 1, wherein the first location and the second location correspond to a sporting event with a plurality of participants, and the first donation and the second donation are for at least one of the plurality of participants.

5. The method of claim 1, wherein the first location is one or more of a first seating section, row, or seat within a stadium where a sporting event takes place, and the second location is one or more of a second seating section, row, or seat within the stadium.

6. The method of claim 1, wherein the first potential donor is a first group of potential donors associated with the first location, and the second potential donor is a second group of potential donors associated with the second location, and further comprising:
controlling the display to present first donations from the first group of potential donors in juxtaposition with second donations from the second group of potential donors to implement a competition between the first group of potential donors and the second group of potential donors.

7. The method of claim 6, controlling the display to:
present the first donation associated with the first location and the second donation associated with the second location while a sporting event is taking place; and
offer an incentive to the first group of potential donors or the second group of potential donors based on whether the first donation is greater than the second donation.

8. The method of claim 1, further comprising controlling the display to present a selectable option enabling the first potential donor to direct the first donation to one of: a NIL compensation program associated with one or more participants in a sporting event, or an athletic revenue sharing fund of an institution associated with the sporting event.

9. The method of claim 1, wherein associating the first potential donor with the first location comprises detecting, by a processor of a mobile device of the first potential donor, a signal transmitted by or associated with a location identifier deployed at or associated with the first location, wherein the location identifier comprises at least one of: a short-range wireless transmitter, a near-field communication tag, a ticket barcode associated with an event corresponding to the first location, an ultrasonic emitter, or a wireless local area network access point associated with the first location.

10. The method of claim 1, wherein the first location comprises a digital donor community corresponding to an event, the digital donor community comprising a group of potential donors associated by a common affinity, interest, or affiliation, wherein membership in the digital donor community is not defined by physical presence at a common physical venue.

11. A system comprising:
one or more processors; and
one or more non-transitory computer-readable media storing instructions that, when executed by the one or more processors, cause the one or more processors to:
associate a first potential donor with a first location corresponding to an event, the association based on at least one of: a scan of a first QR code associated with the first location, or a determination that location data for a mobile device of the first potential donor falls within a first geofenced area associated with the first location;
associate a second potential donor with a second location corresponding to the event, the association based on at least one of: a scan of a second QR code associated with the second location, or a determination that location data for a mobile device of the second potential donor falls within a second geofenced area associated with the second location;
receive a first donation from the first potential donor and a second donation from the second potential donor; and
control a display to present the first donation associated with the first location and the second donation associated with the second location.

12. The system of claim 11, wherein the instructions further cause the one or more processors to:
capture donor identification data from the first potential donor or the second potential donor in connection with the first donation or the second donation;
transmit the donor identification data to a donor management system associated with the event; and
control the display to provide access to a ticketing platform associated with the event.

13. The system of claim 12, wherein controlling the display to provide access to a ticketing platform comprises, for each of the first potential donor and the second potential donor, presenting a selectable link that, upon selection, navigates a mobile device of the potential donor to a ticketing portal configured to enable the potential donor to purchase one or more tickets to the event.

14. The system of claim 11, wherein the instructions further cause the one or more processors to:
receive a commitment from a sponsor to provide matching donations corresponding to at least a portion of donations associated with one or more of the first location or the second location during a specified time period; and
control the display to present matching donation information associated with the sponsor commitment to one or more potential donors.

15. The system of claim 11, wherein each of the first location and the second location is associated with a plurality of donors, and wherein the instructions cause the one or more processors to control the display to present, for each of the first location and the second location, an aggregate donation total reflecting cumulative donations received from all donors associated with the respective location.

16. The system of claim 11, wherein the instructions further cause the one or more processors to establish a persistent communication channel with the display and push updated donation information to the display via the persistent communication channel in real time as donations are received.

17. A non-transitory computer-readable medium storing instructions that, when executed by a processor, cause the processor to:
associate a first potential donor with a first location corresponding to a sporting event;
associate a second potential donor with a second location corresponding to the sporting event;
receive a first donation from the first potential donor for at least one participant in the sporting event and a second donation from the second potential donor for the at least one participant;
control a display of a mobile device to present, in real time while the sporting event is taking place, the first donation associated with the first location and the second donation associated with the second location to facilitate a competition between the first potential donor and the second potential donor;
determine a winner of the competition based on a comparison of the first donation and the second donation; and
control the display to present an incentive available to the winner of the competition.

18. The computer-readable medium of claim 17, wherein associating a first potential donor with a first location comprises at least one of: receiving input indicating the first potential donor has scanned a QR code associated with the first location, or determining that location data for a mobile device of the first potential donor corresponds to a geofenced area associated with the first location.

19. The computer-readable medium of claim 17 wherein the instructions further cause the processor to establish a persistent communication channel with the display and push updated donation totals to the display via the persistent communication channel in real time as donations are received during the sporting event, so that the first potential donor and the second potential donor can observe the competition as it progresses.

20. The computer-readable medium of claim 17, wherein the instructions further cause the processor to generate, for presentation on an administrative dashboard accessible to an administrator, aggregated donation data across a plurality of locations associated with one or more events, the aggregated donation data including at least:
a total donation amount;
a total number of donors;
an average donation amount; and
a ranking of participating locations by total donations received.
